(19) United States
(12) Patent Application Publication
(10) Pub. No.: US 2010/0192735 A1
(43) Pub. Date: Aug. 5, 2010

(54) Release auto-grip locking tool

(76) Inventor: Ara Don Kelly, Vancouver, WA (US)

Correspondence Address: Ara Don Kelly, P.O. BOX 821717, Vancouver, WA, 98682-0039, US

(21) Appl. No.: 12/798,881

(22) Filed: Apr. 12, 2010

Related U.S. Application Data
(63) Continuation-in-part of application No. 11/236,002, filed on Sep. 26, 2005, now abandoned.

(51) Int. Cl. B25B 7/12

(52) U.S. Cl. 81/355

(57) ABSTRACT

A release auto-grip locking tool designed for single hand use while maximizing safety and ease of use by way of isolating the release auto-grip feature from the leveraged power-gripping feature thus maximizing power to the jaws.

The release auto-grip feature wherein the tool by design constantly applies a limited closing pressure to the jaws and where releasing the tool closes the tool jaws on any size work piece within the capability of said tool. The locking feature also works independently of the other features making possible a ratcheting locking feature that allows a user to increase locked gripping force to a work-piece without removing the tool.

### CROSS-REFERENCE TO RELATED APPLICATIONS

As set forth in the Application Data Sheet, this utility application is a Continuation in Part of U.S. patent application Ser. No. 11/236,002 filed Sep. 26, 2005 now abandoned, and claims benefit of the subject matter in common with that application.

### STATEMENT REGARDING FEDERALLY SPONSORED RESEARCH OR DEVELOPMENT

Not Applicable

### REFERENCE TO SEQUENCE LISTING

Not Applicable

### BACKGROUND OF THE INVENTION

Self-adjusting pliers are used to grip a workpiece with one hand, without the need to pre-adjust the pliers to accommodate the size of the workpiece.

There have been a number of pliers that have jaws, one of which can be moved parallel to the other jaw and locked on a workpiece. Primarily these are toggle action pliers of a type that are exemplified by U.S. Pat. No. 358,746. With pliers of this toggle type, the jaws do stay parallel. In addition a condition which is not advantageous is the amount of pressure released to a users hand when the tool un-locked.

There have also been proposed certain parallel jaw type wrenches in which the jaws operate with a rack, such as, for example, illustrated in U.S. Pat. No. 4,094,215. In effect, the instant invention is a combination of pliers action in which squeezing the body and power lever together grip a workpiece, and of a parallel jaw locking type wrench. The construction obviates release systems that are in need for conventional toggle wrenches and improves upon the adjustable wrench. In addition the open-end wrench feature incorporates the ratchet type locking adjustment capability in addition to providing leveraged clamping power. A rear handle compression device continually urges the jaws toward each other eliminating wasted user hand pressure while maximizing clamping power to the user. The power lever contacts the lock gear is the large lock gear of the dual-gear for optimum ease of use thru power leveraged gear reduction. The rack gear is the small rack gear of the dual-gear that engages the rack of the movable jaw, maximizing clamping power on any size work piece within the capacity of the tool.

Another advantage is to have the jaws move away from one another when squeezing the handles together for easy single-handed use. When positioning a workpiece between the jaws and squeezing the handles together the jaws open to engage the workpiece while releasing the handles and begins applying a limited force to the workpiece.

The present invention relates to a hand tool that grips a workpiece and, more particularly, to such a tool that is locking, self-adjusting for single hand use by release-grip. That is, the pliers automatically adjust with single-handed use, to the size of the workpiece so long as the workpiece can fit between the jaws of the tool. A pair of pliers for example, illustrated in U.S. Pat. No. 4,651,598 FIG. 1 shows a typical open rear handle configuration while grasping a work piece, that work piece could round off, crack or giveaway causing an undesirable pinch point hazard to the user. The present invention utilizes a single rear pivot point for the handles eliminating this pinch point. Ordinary adjustable spanners do not have this pinch point, but they also do not self-adjust.

Prior to use on a workpiece the jaws must be adjusted manually to accommodate different size work pieces, this extra step makes conventional spanners less efficient compared to self-adjusting tools that could accomplish the same task. The spanner also cannot lock or apply a levered force against a work piece, as a result the jaws could round off the corners of a bolt, slipping off causing an undesirable hazard to the user. Therefore, there is a need for a release auto-grip locking tool that can maximize levered clamping power, applying a force against a workpiece while maintaining parallel gripping faces of the jaws and reduce slipping and pinching hazards to a user.

### BRIEF SUMMARY OF THE INVENTION

The present invention provides a release auto-grip locking tool that maximizes single handed ease of use thru leveraged clamping power to a workpiece that is located between its jaws to grip or lock the workpiece. In addition, parallel gripping surfaces maximize levered clamping power thru gear reduction substantially improving safety and ease of use.

The position of the handles controls the jaws. The gripping jaws are operatively associated with the dual-gear that engages the rack of the movable jaw thru the pivoting power lever. The speed link connects the moveable jaw to the upper handle. The movable handle positions the gripping jaws to auto-grip a work piece. Squeezing the power lever towards the lower fixed handle transfers the single-handed user gripping force by engaging and rotating the lock gear and at the same time rotates the rack gear moving the lower movable jaw towards the fixed jaw. The workpiece can be any size that fits between the gripping jaws.

As the jaws remain parallel, this tool design is particularly useful in applications for which spanners are used. The rear spring for the handles continually urge the jaws towards each other this allows a user the benefit of repositioning the tool without removing it from a bolt or other work piece.

The tool is release grip self-adjusting in that releasing of the handles moves the jaws towards each other, a simple squeeze on the power lever closes the jaws gripping any size work piece within the capacity of the tool. Regardless of the size of the workpiece, you only need one hand to grip and lock onto a workpiece.

Because the gripping surfaces move parallel to each other the tool can grip hex nuts or bolts using smooth gripping surfaces, in the manner of a “Crescent” wrench in addition with the release auto-grip locking tool you will not need to remove the tool from the work piece to reposition it.

A preferred embodiment of the present invention is a tool that includes two handles: one a fixed handle with a lower body, a neck section and upper fixed jaw. An upper movable handle in addition a movable lower jaw that carries a rack. A speed link connecting lower jaw and upper handle. A power lever and locking lever engage the lock gear. The dual-gear comprises a large outer lock gear as needed and a small inner rack gear that constantly engages the rack.

This preferred embodiment also includes a sliding jaw element that is confined parallel with the fixed jaw by guide channels cut out of the neck portion of the lower handle.

In addition another benefit of the release auto-grip locking tool is a faster opening and closing speed of the jaws by way of the speed link, the speed link connects the upper handle and lower sliding jaw.

When a user holds the tool in a position to operate it, but not exerting any substantial force against the handle sections, the handle sections and jaws are biased to a fully closed position, at which point the handle sections reach their limit of travel away from each other. When the user's hand squeezes the lower handle and power lever toward each other, the power lever pivots to engage the lock gear, the sliding jaw approaches the fixed jaw to engage a workpiece as the rack gear rotates and moves the lower jaw rack. The dual-gear compounds the force applied by the user's hand against the workpiece through the power lever to the tool's jaws. Consequently, the pivoting power lever and dual-gear define a compound leverage mechanism, and the tool can deliver a force to its jaws and workpiece of a magnitude that is approximately six times the force as compared to simple similar size pivoted pliers design.

Other embodiments of the present invention will accomplish other levels of leverage magnitude force. It is to be understood that in the preferred embodiments, the release auto-grip locking tool power lever can have any configuration that allows it to perform at least three interrelated functions with respect to the fixed handle and the pivoting handle.

First, until a user applies force to the lower handle and power lever, the lock gear is free to rotate without any interference from said power lever.

Second, when a user is not applying force to the handles the jaws continually urge towards each other until they auto-grip a workpiece or are fully closed.

Third, after the power lever pivoting to the point of contact with the lock gear and said power lever rotating said lock gear in a jaw closing direction.

The brief description herein of specific embodiments shall not limit the invention from various alternative forms of the invention falling within the same spirit and scope of the defined claims.

### BRIEF DESCRIPTION OF THE SEVERAL VIEWS OF THE DRAWING

FIG. 1 is a side view of the reverse auto-grip locking tool.

FIG. 2 is a side view of the reverse auto-grip locking tool with the top laminate of the upper and lower handle removed.

FIG. 3 is an angle view of the reverse auto-grip locking tool with the top laminate of the upper and lower handle removed.

FIG. 4 is an angle view of the lower jaw assembly.

FIG. 5A lower jaw laminate.

FIG. 5B upper jaw and lower handle laminate.

FIG. 5C upper handle filler laminate.

FIG. 5D upper handle laminate.

FIG. 5E reverse drive lever and dual gear assembly.

### DETAILED DESCRIPTION OF THE DRAWINGS

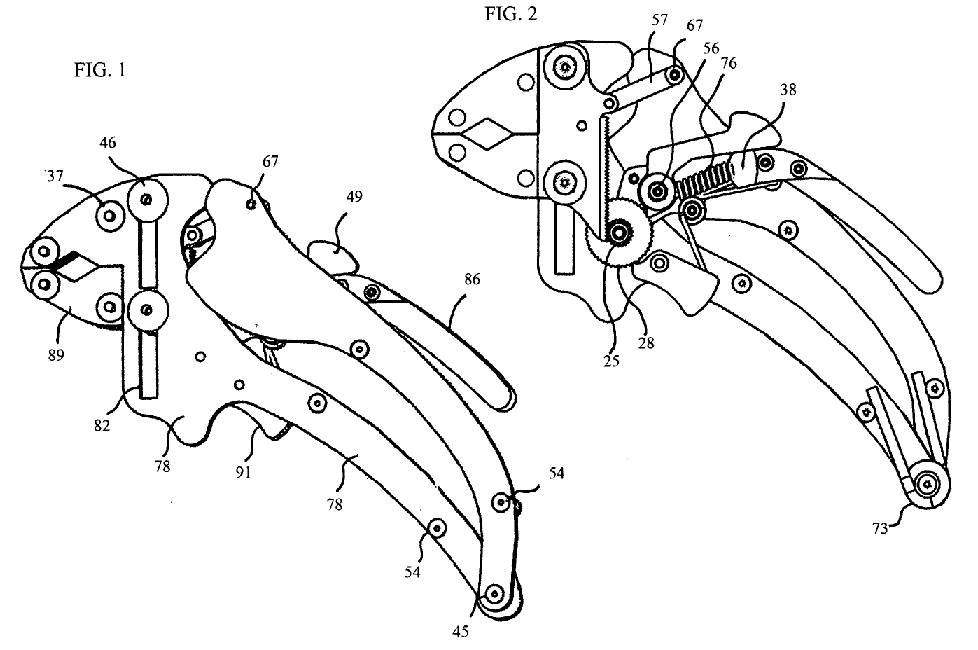

FIG. 1 #67 Upper handle speed-link support pin.

FIG. 2 is a side internal view of the release auto-grip locking tool with the top laminate of the upper and lower handle removed.

FIG. 3 is an angle view of the release auto-grip locking tool with the top laminate of the upper and lower handle removed.

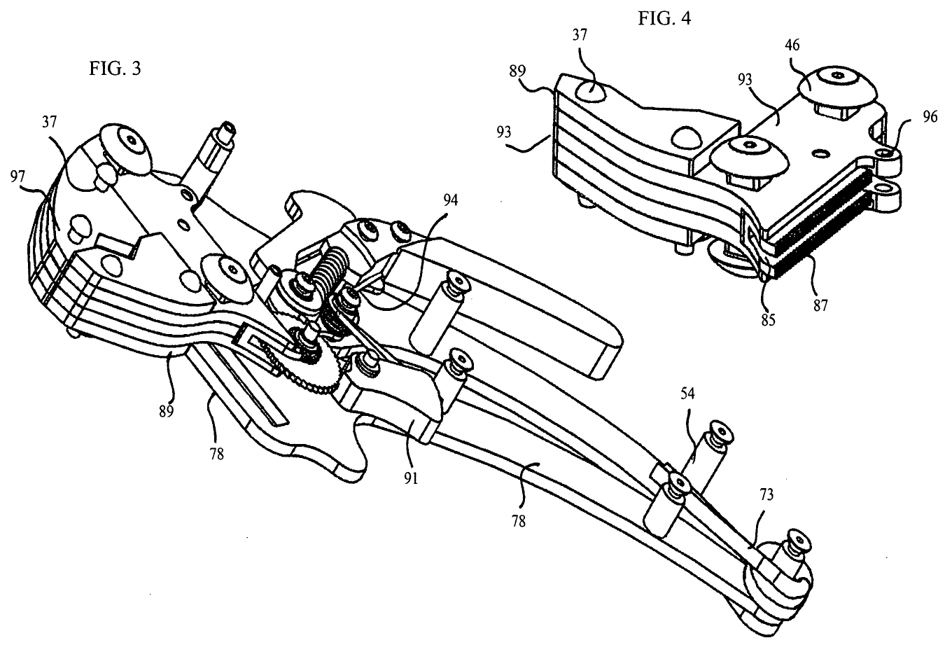

FIG. 4 is an angle view of the lower jaw assembly.

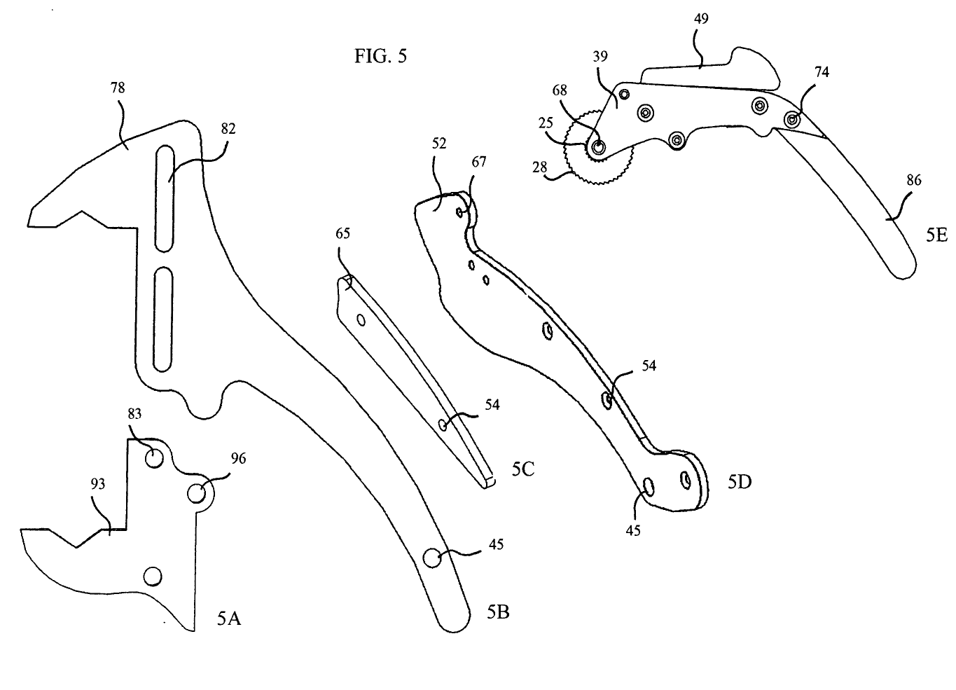

FIG. 5A lower jaw laminate.

FIG. 5B lower handle laminate includes upper jaw and guide slot for lower jaw.

FIG. 5C handle laminate filler material.

FIG. 5D upper handle laminate includes supporting means for speed-link.

FIG. 5E power lever includes attached dual-gear assembly and engagement lever.

FIG. 5B #78 upper jaw end of lower handle laminate. These one-piece laminates comprise one or more elements of the upper jaw, guide slots for the lower jaw the lower handle and rear pivot point for the upper handle, and support for the inner laminate filler material.

FIG. 3 #89 Lower jaw outer laminate parallel guide. Lower jaw parallel guides slide next to the lower handle outer laminates illustrated position with jaws closed in FIG. 1.

FIG. 2 #57 Upper handle to lower jaw speed-link that provides the release auto-grip feature from the movement of upper handle that is in reverse direction of the lower jaw.

FIG. 5D #52 Upper handle laminate provides the support for the inner laminates structural filler material, as well as the rear pivot and upper handle to lower jaw linkage support.

FIG. 5E #86 Power-lever located between the upper handle laminates #52 in FIG. 5D as illustrated in FIG. 2 providing the reversing force for gripping and locking a work piece.

FIG. 5E #39 Reverse power-lever laminate gear end provides support for the dual-gear. This is the gear end of the reversing power-lever located between the upper handle laminates #52 in FIG. 5D

FIG. 2 #76 Reverse drive lever disengagement thumb release spring providing a solid on/off feature for additional reversing force for gripping and or locking a work piece by way of the outer lock dual-gear FIG. 2 #28 to the jaw rack by way of the inner rack gear of the dual-gear FIG. 2 #25.

FIG. 5E #74 Reverse drive lever pin or rivet

FIG. 5E #49 Reverse drive lever gear disengagement thumb release

FIG. 2 #56 Reverse drive lever gear disengagement thumb release pivot point

FIG. 2 #38 Reverse drive lever gear disengagement spring support

FIG. 4 #93 Lower Jaw Laminate

FIG. 5B #82 Lower jaw guide pin slot guides

FIG. 5C #65 Laminate filler material

FIG. 5A #83 Lower jaw guide pin location

FIG. 4 #46 Lower jaw guide pins

FIG. 5A #96 Lower jaw connecting speed-link pin hole

FIG. 5D #67 Upper handle to lower jaw linkage upper pin or rivet support

FIG. 4 #87 Small diameter gear rack

FIG. 2 #25 Small diameter rack gear on dual gear

FIG. 5E #68 Dual gear pin or bearing support

FIG. 4 #85 Large diameter gear of dual gear clearance slot

FIG. 5E #28 Large diameter gear on dual gear

FIG. 5D #45 Upper and lower handles pivoting pin location

FIG. 2 #73 Upper handle return spring

FIG. 3 #94 Release drive lever and lock engagement lever spring

FIG. 1 #37 Fixed rivets

FIG. 5D #54 Upper handle laminate typical fixed rivet location

FIG. 1 #91 Lock engagement lever

FIG. 3 #97 Upper jaw inner laminate

### DETAILED DESCRIPTION OF THE INVENTION

It is to be understood that the Figures and descriptions of the preferred embodiments of the present invention are to illustrate a clear understanding of the present invention, while for purposes of clarity, other elements because they do not facilitate a better understanding of the present invention were eliminated. Other elements may be advantageous in order to implement the present invention; one skilled in the art will recognize this. However, because such fundamentals are well known in the art, a discussion of such fundamentals is not provided herein.

In the present Detailed Description of the Invention, the preferred embodiments of the invention are illustrated as a release auto-grip locking tool of a distinct configuration. A person skilled in the art will recognize that the present invention may take on additional configurations and will be able to construct those configurations based upon the description presented herein.

It should be understood that other embodiments of the present invention could be capable on any single-handed use requiring leverage-applied force to any workpiece within the capacity of the tool for, but not limited to, gripping, crimping and locking.

The preferred embodiments of the present invention are illustrated herein in a normal operating position described to, and in terms such as top or upper, bottom or lower, front, back, and the like, are used with reference to the normal operating position of the preferred embodiments. The preferred embodiments of the present invention may be manufactured in orientations other than those described or illustrated herein.

Unless otherwise indicated, any numbers, dimensions, angles or orientations used in the specification and claims are to be understood as approximate. It is to be appreciated that the numbers given are reported as accurately as possible. The drawings show one of many preferred embodiments of the present invention.

The tool shown in the drawings is a release auto-grip locking tool that automatically adjusts to any size work piece within the capacity of said tool. The power levers' active fulcrum is the same as that of the dual-gear. This design offers a leveraged advantage that is far greater at the lower jaw rack driven by the power lever thru the small rack gear of the dual-gear. This leveraged advantage allows a user to grip a workpiece with less force required on the user's hand. The release grip feature assist a user by urging the jaws closed and not requiring the user to apply additional force to compress the jaws against the force common in pliers that hold the jaws open.

With respect to the handles, one of these handles is a fixed handle and the other is a pivoting handle. The release auto-grip tool also includes a pivoting power lever that is the gripping part of the self-adjusting mechanism of said tool. In describing the tool's operation, the fixed handle can be viewed as the static component of the tool with the movement of the pivoting handle, power lever and the sliding jaw occurring in relation to the fixed lever. The user can squeeze the handle sections of the fixed and pivoting handle toward each other with one hand to cause the sliding jaw to move away from the fixed jaw. The sliding jaw moves at a faster rate than the pivoting handle while the jaws open or close.

Another benefit is that the operational hand movement on the part of a user is less, a result of the accelerated speed link movement on the sliding jaw end of said link.

It is to be understood that any suitable configuration can be constructed of metal, plastic or other suitable material for the fixed handle, pivoting power lever, pivoting handle, fixed jaw, sliding jaw, or other parts. In the description laminate construction for the fixed handle, the pivoting handle and power lever are illustrated. It is to be appreciated that solid piece construction or laminate may be used.

It is to be understood that in the preferred embodiments, the power lever can have any configuration or material that allows it to perform at least three interrelated functions with respect to the fixed handle and the pivoting handle.

First, until a user applies force to the lower handle and power lever, the power lever maintains its pawl in a position in which the teeth of the pawl are not engaging the dual-gear teeth.

Second, when a user is not applying force to the handles the jaws continually urge towards each other into the closed position.

Third, during the time that the teeth of the power lever pawl engage the teeth of the large lock gear of the dual-gear the pivoting power lever maintains a temporarily active force rotating the dual-gear always in like direction with said power lever.

It is to be understood as to this invention that it should not be limited to the embodiments disclosed herein; it is the intent to cover all modifications within the spirit and scope of the invention, defined by appended claims.

The power lever is operably connected to the rack of the sliding jaw thru the dual-gear. The dual-gear comprises a large outer lock gear utilized by the power and locking levers and a small inner gear utilized by the rack of the sliding jaw.

A work piece of the tool is under load when a user is squeezing the power lever and lower handle section toward each other, the power lever pawl engages the large lock gear of the dual-gear to grip a work piece. The tool locks on a work piece when a user simply releases the lock lever that is urged toward the lock gear. The tool would not be under load without the user applying force. The urging of the jaws to close as part of the tools built-in release auto-grip feature would not constitute the tool being under load.

The power lever can take various forms as well the type of contact or gripping surface to engage a dual-gear or other leveraged force transfer component. The preferred embodiments of the present invention as illustrated in FIGS. 1 thru 5 are of laminate construction.

The tool includes a power lever FIG. 1 #86 that defines a flat plate on which additional laminate parts fastened in place with pins or rivets to build a laminated power lever structure.

The fixed jaw provides sliding jaw guides FIG. 5B #82 of the preferred embodiment fixed jaw shown in FIG. 5B #78 formed from metal sheets having guide channels cut in the two outer laminates in the neck section of the fixed jaw lower handle body. A rivet or pin passes through the laminated segments holding the laminates together.

The gripping surfaces of the jaws can be of a variety of styles for a specific job application.

The handles can assume any suitable configuration and can be constructed of any suitable material. For example, it can be a single-piece handle.

The sliding lower jaw rack as illustrated in FIG. 4 #87 has a groove or channel FIG. 4 #85 to accommodate the large lock gear FIG. 2 #28 of the dual-gear. FIG. 3 illustrates this clearance. The leveraged advantage of the large lock gear of the dual-gear is thru reduced pressure needed to grip a work piece in addition to utilize the release of the lock lever FIG. 1 #91.

The small rack gear FIG. 2 #25 of the dual-gear offers a leveraged advantage over the large lock gear of the dual-gear as it moves the rack FIG. 4 #87.

The power lever gear disengagement thumb release FIG. 1. #49 can be toggled on or off as needed to engage or disengage the power lever from the dual-gear.

The speed link FIG. 2 #57 pivots in the same direction as the sliding jaw, in addition the speed of the connection point (see FIG. 4 #96) will always exceed that of the upper handle connection point for the speed link rivet or pin FIG. 2 #67.

The Lower jaw guide pins FIG. 4 #46 maintain parallel alignment between upper and lower jaws by way of the lower-jaw guide pin slots FIG. 5B #82.

The Lock engagement lever FIG. 3 #91 locks the jaws to a work piece by locking the large lock gear. The lock gear moves as one with the small rack gear of said dual-gear.

The power lever broadly defines three elements: a leveraged gripping force, a released gripping force and a lower user hand gripping force requirement for said force compared to a typical hand tool of this type seen in prior art. The required force exerted against the power lever by the user is minimized by way of the small rack gear of the dual-gear to the rack of the moveable jaw as it applies a leveraged force to the workpiece.

The tool has jaws, handles and levers that are solid or formed from flat sheets typically of a uniform thickness that are secured by pins or rivets.

At pivot points as in the speed link FIG. 2 #57 or FIG. 1 #45 the pin or rivet would also provide a bearing surface.

The outer laminates of the lower jaw FIG. 1 #89 additionally provide a stable slide path along the neck area FIG. 3 #78 of the fixed jaw body.

The moveable jaw laminates FIG. 4 #93 are typically made of a solid material for added strength. Between laminates, may have a filler material FIG. 5C #65 that may not be solid to lighten the tool.

Lower jaw pin guides could be a press fit thru the jaw laminates or filler. As seen in FIG. 5A #83 the guide pin location provides a secure parallel jaw sliding operation for gripping a work piece. Guide pins can also be pins that serve as bearing surface as FIG. 5A #96 of the upper speed link connecting pin.

When the user applies force to the lower handle section FIG. 1 #78 and pivoting power lever FIG. 5E #86 to squeeze them together, force is not seen at the jaws until the tooth of the disengagement lever FIG. 1 #49 engages the teeth of the large lock gear FIG. 5 #28 of the dual-gear of said power lever to rotate said gear.

Alternative embodiments should not be considered as a departure from the subject invention. It will be evident to those skilled in the art that variations of the present invention can be made without departing from the invention as defined in the appended.

What I claim as my invention is:

1. A release auto-grip locking tool designed for single hand use, comprising:
a) a lower handle with a fixed jaw;
b) a upper handle with a speed link;
c) a lower movable jaw with a rack;
d) a power lever;
e) a lock lever;
f) a dual-gear;
wherein said lower handle with a fixed jaw, said upper handle with a speed link, said lower movable jaw, said power lever, said lock lever, and said dual-gear are operatively connected to each other so as to allow said tool to automatically grip and lock at a desired gripping force without the need for any adjustments needed when a work piece is grasp, simply ratcheting said power lever adds additional leveraged force to the jaws until the desired gripping force is obtained, and to release said work piece requires only the touch from a single finger of the user to said lock lever;
wherein said lower handle with a fixed jaw has elongated parallel guide slots;
wherein said lower handle with a fixed jaw has supporting means for said lower jaw;
wherein said lower handle with a fixed jaw has supporting means for said dual-gear;
wherein said lower handle with a fixed jaw has supporting means for said lock lever;
wherein said lower handle with a fixed jaw has supporting means for said upper handle.

2. The tool of claim 1, further comprising one or more springs.

3. The tool of claim 2, further comprising laminate construction with fixed and movable parts supported by pins and or rivets.

4. The tool of claim 3, further comprising leveraged gripping force thru gear-reduction.

5. The tool of claim 4, wherein the speed link pivots in the same direction the movable jaw.

6. The tool of claim 5, wherein the handles connect at a single rear pivot point.

7. The tool of claim 6, wherein a user simply releases pressure on the handles to urge the jaws to close on any size work piece within the size capacity of the tool.

8. The tool of claim 7, wherein squeezing the power lever and lower handle force all movement of said power lever to drive the jaws in a closing direction.

9. The tool of claim 8, wherein the power lever has no effect on the movement of the jaws to open or close while not engaged with the dual-gear.

10. The tool of claim 9, wherein the power lever engages and rotates the dual-gear to apply the leveraged gripping force thru gear reduction to the jaws closing direction.

11. The tool of claim 10, wherein the force on the dual-gear from the power lever is always in a jaw closing direction.

12. The tool of claim 11, wherein the small gear of the dual-gear always drives the jaw rack in a jaw closing direction.

13. The tool of claim 12, wherein engaging the lock lever to the large gear of the dual-gear prevents said large gear from moving in a jaw opening direction.

14. The tool of claim 13, wherein the lock lever while being engaged to the dual-gear allows said dual-gear to continue rotating as a user squeezing the power lever and lower handle towards each other thus ratcheting the jaws in a closing direction.

15. The tool of claim 14, wherein the power lever and dual-gear share the same pivot point.

16. The tool of claim 15, wherein the lower jaw rack has a channel or groove between the rack teeth that allow free rotational clearance for the large gear of the dual-gear.

17. The tool of claim 16 wherein the lock lever is engaged and ready to lock and ratchet as needed without any applied pressure from the user.

18. The tool of claim 17 wherein at a resting state without any user applied pressure to the tool will have the jaws closed at the urging of the upper handle thru the speed link.

19. The tool of claim 18 wherein the power lever is held open by design without any direct contact to the dual-gear teeth thus allowing free rotation of said dual-gear.
